(19) United States
(12) Patent Application Publication
(10) Pub. No.: US 2004/0158177 A1
(43) Pub. Date: Aug. 12, 2004

(54) Pneumatic chest compression vest with front panel bib

(76) Inventors: Nicholas P. Van Brunt, White Bear Lake, MN (US); Donald J. Gagne, St. Paul, MN (US)

Correspondence Address: BARNES & THORNBURG, 11 SOUTH MERIDIAN, INDIANAPOLIS, IN, 46204

(21) Appl. No.: 10/774,098

(22) Filed: Feb. 6, 2004

Related U.S. Application Data
(63) Continuation of application No. 09/387,319, filed on Aug. 31, 1999, now abandoned.

(51) Int. Cl. A61H 31/00

(52) U.S. Cl. 601/44

(57) ABSTRACT

A pneumatic chest compression vest is disclosed for the purposes of clearing the lungs of mucus and producing quality sputum samples for analysis. The vest is comprised of a belt and a front panel which has an air bladder that applies a compressive force to the region of the chest that encompasses the lungs mounted on its inner surface. The belt extends around a patient to hold the vest in the correct position during treatment.

### CROSS-REFERENCE TO RELATED APPLICATION(S)

This application is related to “Chest Compression Vest with Connecting Belt” and “Method and Apparatus for Inducing Sputum Samples for Diagnostic Evaluation”, which were filed on the same day and also assigned to American Biosystems.

### BACKGROUND OF THE INVENTION

The present invention relates to chest compression devices and in particular to a high frequency chest wall oscillator device.

Manual percussion techniques of chest physiotherapy have been used for a variety of diseases such as cystic fibrosis, emphysema, asthma, and chronic bronchitis, to remove the excess mucus that collects in the lungs. To bypass dependency on a care giver to provide this therapy, chest compression devices have been developed to produce high frequency chest wall oscillation (HFCWO), the most successful method of airway clearance. In addition, these devices can be utilized for induction of high quality sputum samples for screening and diagnosing a number of pulmonary disorders such as lung cancer, asthma, chronic obstructive pulmonary disease (COPD), tuberculosis, Pneumocystis carinii pneumonia (PCP), inflammation, and infection.

The device most widely used to produce HFCWO is the ABI Vest Airway Clearance System by American Biosystems, the assignee of the present application. A description of the pneumatically driven system can be found in the Van Brunt et al. patent, U.S. Pat. No. 5,769,797, which is assigned to American Biosystems. Another pneumatic chest compression device has been described by Warwick et al., U.S. Pat. No. 4,838,263.

Pneumatically driver, HFCWO produces substantial transient increases in the airflow velocity with a small displacement of the chest cavity volume. This action produces a cough-like shear force and reduction in mucus viscosity that results in an upward motion of the mucus.

A shortcoming of the design of the vests used by these devices is that the compressions are not concentrated on the region of the chest which directly surrounds the lungs. An inflatable air bladder that provides the compressive force extends all the way around the patient including the back. The bladder has a rather large volume which renders it inadequate to create the magnitude of force necessary on regions encompassing the lungs to clear the lungs of mucus or induce deep sputum that, for example, provides optimal samples for lung cancer screening. In addition, since the vests close in the front, the air bladder is not continuous over the chest. The air bladder's design does not allow it to reach to the highest lobes of the lung, and it extends too low resulting in compression on the stomach, a particular problem for short adults and children. This results in inefficient and insufficient mucus induction and mobilization. Thus, there remains a need to design a vest which focuses the force in the proper regions to give optimal results.

Prior art vests, when fastened to the patient and not inflated, take on the shape of the torso. When inflated they bow outward. The outer material is not rigid enough to maintain its shape., and so the vest takes on a more circular shape. The outward force, which causes the bowing, increases the volume of the air bladder, but it is more desirable to have the increase in volume result from a change in the shape of the chest. Therefore, a vest which maintained its shape would be more efficient, because the outward force that causes the vest to change shape would not cancel out the inward compressive force.

The previous vests were designed for one person to use multiple times. The durable material that is used makes the vest too expensive to be utilized for a single use and cannot be easily and cleanly burned for disposal. For analysis of sputum samples, though, generally the patient only needs the vest one time. The vests, however, cannot be used by multiple patients, because mucus is expelled onto the vest by each patient, and the vests cannot be sterilized between uses. Therefore, there is also a need for a vest which is cost effective for single-use.

### BRIEF SUMMARY OF THE INVENTION

The present invention is a pneumatic chest compression vest which loosens and helps remove mucus from a person's lungs or induces production of sputum samples for further diagnostic analysis. The vest is designed to focus the compressive force on the region of the chest which encompasses the lungs.

The vest includes a front panel having a central bib portion and side portions. An air bladder is mounted to the inner surface of the front panel. Air ports and removable air couplings on the front panel are in communication with the air bladder. When inflated, the air bladder applies a compressive force focused on the region of the chest which encases the lungs.

### BRIEF DESCRIPTION OF THE DRAWINGS

FIG. 1 shows a person wearing a pneumatic chest compression vest.

FIG. 2 is a front view of a pneumatic chest compression vest.

FIG. 3 is a back view of a pneumatic chest compression vest.

FIG. 4 is a side view of an air coupling connected to a hose.

FIG. 5 is a top view of a suspender.

FIG. 6 shows where a person's lungs are located relative to the pneumatic chest compression vest.

FIG. 7 is a graph illustrating the enhanced performance of a pneumatic chest compression vest in the preferred position.

### DETAILED DESCRIPTION

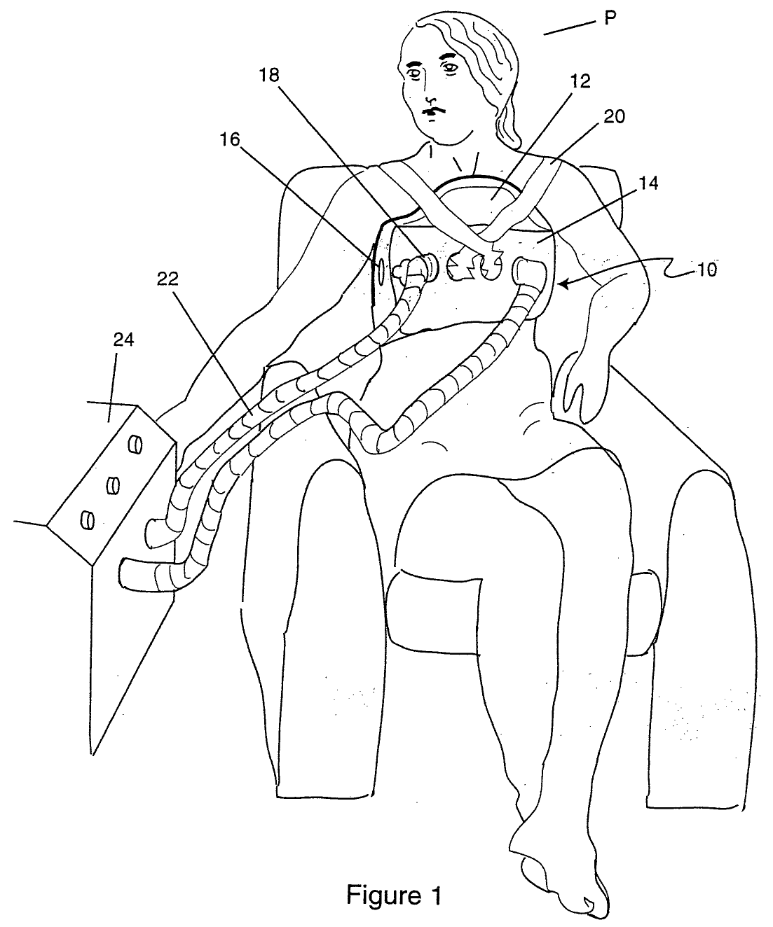

FIG. 1 shows pneumatic chest compression vest 10 of the present invention fitted onto patient P. Pneumatic chest compression vest 10 is shown with front panel 12, belt 14 with belt holes 16, air couplings 18, suspenders 20, hoses 22, and pneumatic pressure generator 24. Front panel 12 of pneumatic chest compression vest 10 covers from approximately the bottom of the patient's rib cage to near the patient's collar bone and extends over the front of the patient's chest to under the patient's arms. Belt 14, which is attached to one side of front panel 12, wraps around the patient's back and across front panel 12. Pneumatic chest compression vest 10 is secured by aligning belt holes 16 with air ports (not shown) on front panel 12 so that air couplings 18 can insert through belt holes 16 and the air ports. Suspenders 20 are also attached to secure pneumatic chest compression vest 10 in place. One end of hoses 22 attaches to air couplings 18 and the other end attaches to pneumatic pressure generator 24. Pneumatic pressure generator 24 provides the oscillating pressure to vest 10 to apply compressive force to the patient's chest. Pneumatic chest compression vest 10 and its operation will be described in more detail in subsequent figures.

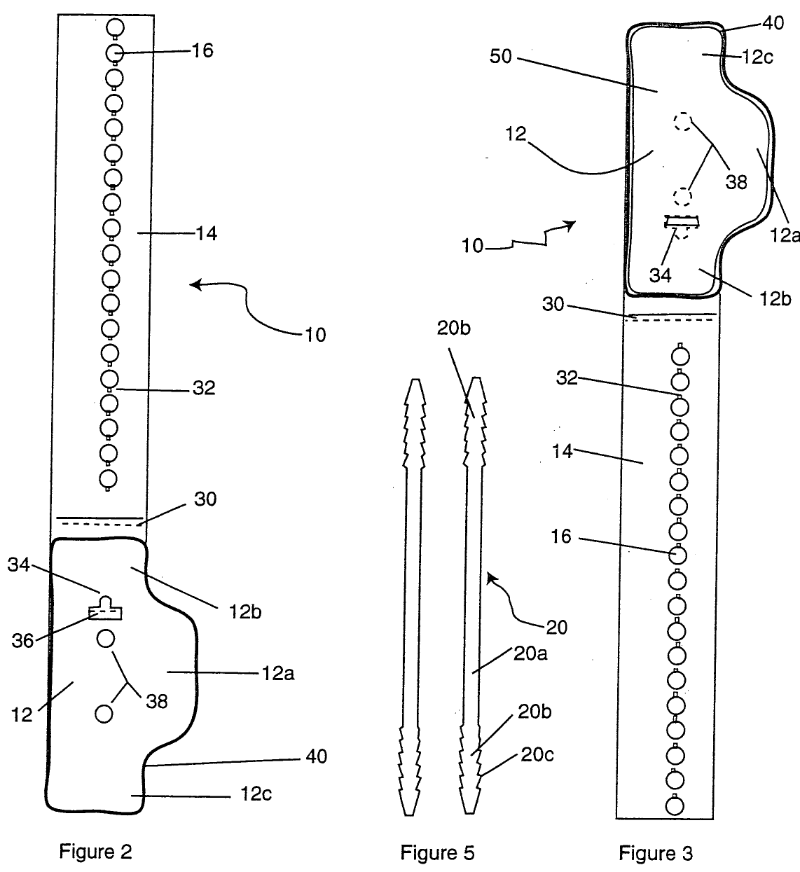

FIG. 2 is a front view of pneumatic chest compression vest 10 laid flat. Front panel 12 is comprised of central bib portion 12a, side portions 12b and 12c, tab 34, tab seams 36, air ports 38, and liner seam 40. Belt 14, which attaches to front panel 12 at belt seam 30, contains belt holes 16 with slits 32.

Pneumatic chest compression vest 10 wraps around the torso of patient P. Belt 14 of pneumatic chest compression vest 10 extends around the back of patient P and across the outer surface of front panel 12. Belt 14 contains longitudinally positioned belt holes 16 each of which includes a slit 32. Tab 34 is welded onto front panel 12 at tab seams 36 and inserts into one of the belt holes 16.

Pneumatic chest compression vest 10 is secured in place by overlapping belt holes 16 with air ports 38 on front panel 12. The distance between air ports 38 corresponds to a multiple of the distance between each belt hole 16. In a preferred embodiment, the diameter of belt holes 16 and air ports 38 is about 1.4 inches with belt holes 16 centered about 2 inches apart, and air ports 38 are centered about 6 inches apart. Tab 34 is welded to front panel 12 at tab seams 36 so that it aligns with air ports 38 on front panel 12 in such a way that as belt 14 wraps around patient P and extends across the outer surface of front panel 12, tab 34 can insert into a belt hole 16. When tab 34 is inserted into a belt hole 16, corresponding belt holes 16 will align with air ports 38. Once aligned, air couplings 18 can easily be snapped into belt holes 16 and air ports 38 (see FIG. 1). Depending on the circumference of the patient's torso, different belt holes 16 will align with tab 34 and air ports 38. This allows adjustment of pneumatic chest compression vest 10 so that it fits securely around patient P.

Slits 32 are preferably about 0.2 inch long. Slits 32 allow ease of insertion of suspenders 20 into belt holes 16 (see FIG. 1).

Liner seam 40 extends along the perimeter of front panel 12 encompassing central bib portion 12a, which has a preferred height of about 11.75 inches but can be from about 9.0 to about 13.0 inches, and side portions 12b and 12c, which have a preferred height of about 7.75 inches but can be from about 6.0 to about 9.0 inches.

FIG. 3 is a back view of pneumatic chest compression vest 10 laid flat. Front panel 12 includes central bib portion 12a, side portions 12b and 12c, air ports 38 (in phantom), and liner seam 40. A liner 50 is shown welded to the inner surface of front panel 12 along liner seam 40. Belt 14, belt holes 16 with slits 32, belt seam 30, and tab 34 (in phantom) are shown and were described in FIG. 2.

Liner 50 is preferably made of an elastic material such as 4 mil polyethylene, and the remaining parts, except air couplings 18, are made of an inelastic material such as 8 mil polycarbonate. These materials are relatively inexpensive and can be easily incinerated, producing no toxic emissions and little particulate matter for disposal. Liner 50 mounted onto front panel 12 defines an air bladder which is preferably about 21 inches wide.

In operation, the air bladder is inflated via air ports 38 against the chest of patient P to apply a compressive force to the patient's lungs. Side portions 12b and 12c allow the air bladder to extend under the arms of patient P. Thus, the air bladder also compresses the sides of the torso which cover the patient's lungs. Since the air bladder does not extend along belt 14, the compressive force is focused on the proper region for optimal treatment. The combination of a generally rigid outer surface and flexible bladder prevents the vest from taking on a circular shape when the air bladder is inflated. Instead, inflating the air bladder forces the chest to change shape so that most of the motion during compression is inward, and the outward force is minimized. This increases the efficiency of the system. The volume of the air bladder is also reduced over the prior art vests, which makes the system more efficient in terms of applying the same volume of air over a smaller surface area so that the magnitude of force necessary for deep sputum induction is achieved.

Pneumatic chest compression vest 10 is suitable for typical pressure requirements of about 0.5 to about 1.0 P.S.I. and can operate for about 30 to about 45 minutes during an oscillatory chest compression treatment. It may last longer for other less stringent applications.

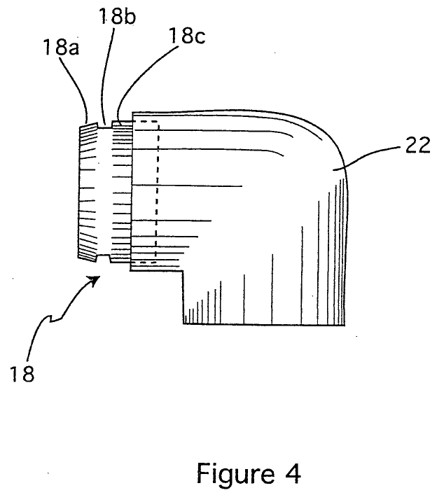

FIG. 4 shows a side view of air coupling 18 connected to hose 22. Air coupling 18 includes head 18a, neck 18b, and body 18c (shown partially in phantom). A portion of hose 22 is shown partially enclosing body 18c of air coupling 18.

In a preferred embodiment, air coupling 18 is made of aluminum with a height of about 3.25 inches. The height of head 18a is about 0.85 inches, neck 18b is about 0.75 inches, and body 18c is about 1.65 inches and is removably attached to neck 18b. Also, hose 22 is angled about 90° at the end that connects to air coupling 18.

Head 18a is beveled with the diameter increasing from about 1.30 inches to about 1.40 inches. The inside diameter of head 18a is about 1.15 inches. Neck 18b has a diameter of about 1.36 inches. Body 18c has a diameter of about 1.50 inches with an inside diameter of about 1.20 inches. The inside diameter of air coupling 18 increases from head 18a to body 18c.

The operation of air coupling 18 is discussed in reference to other parts of pneumatic chest compression vest 10 that are not shown. Head 18a snaps through belt holes 16 and air ports 38 into the air bladder. Neck 18b remains within front panel 12 and belt 14 to secure pneumatic chest compression vest 10 around patient P. Hose 22 connects to and partially overlaps body 18c, which is not connected to neck 18b at this point. Body 18c, when connected to neck 18b, remains on the external side of pneumatic chest compression vest 10. Thus, air coupling 18 has dual functions-to secure pneumatic chest compression vest 10 and provide a coupling to attach hose 22. With hose 22 essentially hanging parallel to front panel 12, hose 22 hangs in a manner which keeps air coupling 18 from pulling outward on pneumatic chest compression vest 10. This type of system reduces the parts needed to operate the vest, which makes it less expensive to manufacture and, therefore, ideal for a disposable vest system.

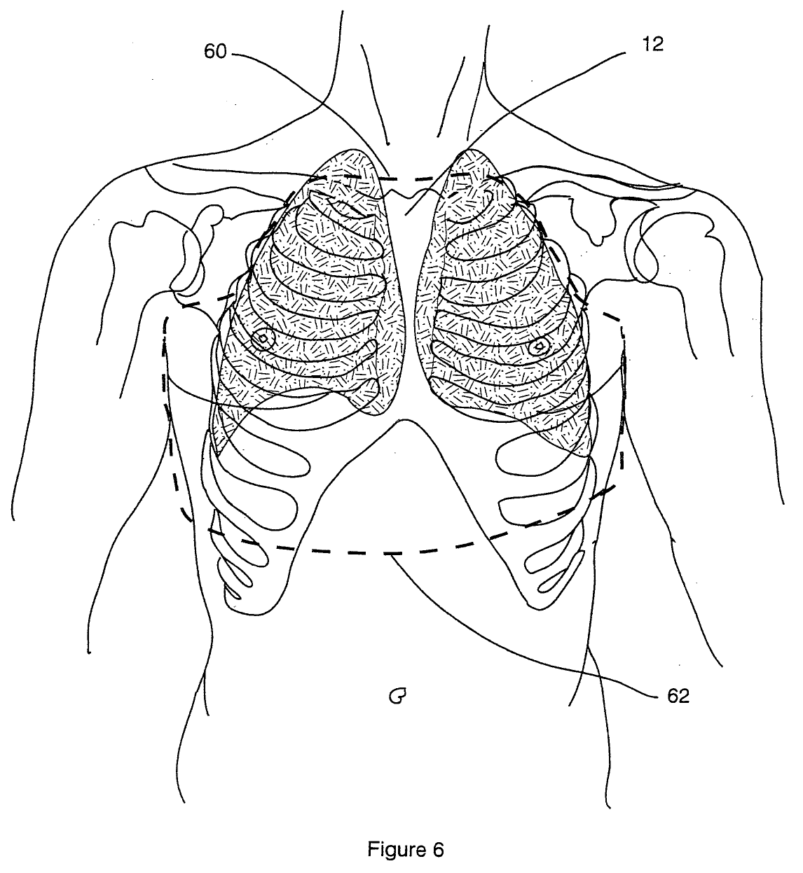

FIG. 5 shows suspender 20 laid flat. Suspender 20 is comprised of strap 20a and serrated ends 20b which include serrations 20c.

In a preferred embodiment, the length of suspender 20 is about 35.0 inches. Serrated ends 20b are about 7 inches long, and each includes about 6 approximately 1 inch long serrations 20c. Strap 20a has a width of about 1.1 inches. Serrations 20c extend out to about 1.6 inches.

In operation, suspenders 20 extend from the front to the back of pneumatic chest compression vest 10 and insert into two of the belt holes 16 on the front and another pair of belt holes 16 in the back. Serrations 20c allow suspenders 20 to be adjusted to the proper length for a secure fit. In a preferred embodiment, suspenders 20 are crossed in front of patient P to minimize movement or slippage of pneumatic chest compression vest 10 during treatment (see FIG. 1).

FIG. 6 illustrates how pneumatic chest compression vest 10 is positioned with respect to the patient's lungs and skeletal structure. An outline of front panel 12 with top edge 60 and bottom edge 62 of pneumatic chest compression vest 10 indicates the region of the patient's chest that is covered.

In operation, front panel 12 preferably covers the region of the torso which encases the lungs of patient P. Top edge 60 is positioned near the patient's collar bone, and bottom edge 62 is positioned near the bottom of the patient's rib cage. This provides a focused compressive force on the lungs with the necessary magnitude to induce deep sputum. Compression on the stomach is minimized, and top edge 60 reaches up to the upper lobes of the lungs to facilitate mucus removal in the upper lobes. Thus, the improved design increases the efficiency of the system to obtain sufficient sputum induction and mucus mobilization.

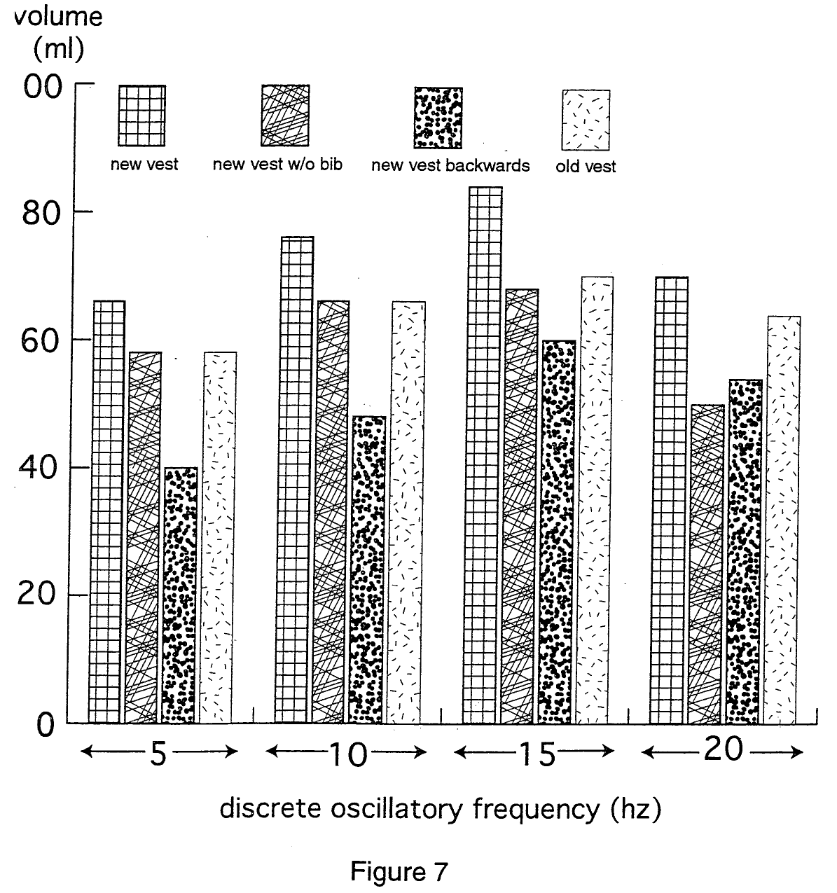

FIG. 7 shows the results of a comparison done between the present invention (new vest), the present invention without the bib section of central bib portion 12a (new vest w/o bib), the present invention positioned backwards (new vest backwards), and a prior art vest (old vest). FIGS. 2 and 3 provide a good view of the bib section of central bib portion 12a. The bib section is the part of front panel 12 that compresses the upper lobes of the lungs. Peak expiratory volume (peak volume) was measured on a single subject with each variation over an oscillatory frequency range between 5 and 20 Hertz. The subject was fitted with a vest and given a mouthpiece with a hose attached to a volume chamber. The volume chamber was equipped with a sensor that measured changes in oscillatory volume. Expiratory volumes were measured with each vest variation tested at 5, 10, 15, and 20 Hertz. The graph illustrates that the present invention in the preferred position (with the front panel over the patient's chest and the bib portion extending to about the collar bone) produces the highest peak volume of airflow. The high peak volume of airflow corresponds to an increased force asserted on the mucus which results in increased mobilization. This data supports the conclusion that the new vest is superior over prior art.

Pneumatic chest compression vest 10 is designed more efficiently to provide effective sputum induction for diagnostic evaluation and mucus mobilization for therapeutic lung clearance. The compressions are focused on all lobes of the patient's lungs with a force that induces deep sputum production and facilitates better lung clearance. The combination of a rigid outer surface and flexible bladder results in more efficiency in that outward forces that change the shape of the vest and cancel inward compressive forces on the chest are minimized. Pneumatic chest compression vest 10 can be composed of materials that satisfy this need and are also relatively inexpensive, and make the vest easy and safe to dispose of. The resulting vest is efficient and cost-effective for single-use.

Although the present invention has been described with reference to preferred embodiments, workers skilled in the art will recognize that changes may be made in form and detail without departing from the spirit and scope of the invention.

1. A pneumatic chest compression vest comprising:
a generally rigid front panel having an outer surface and an inner surface and a central portion and side portions;
a flexible air bladder mounted on an inner surface of the front panel;
a plurality of air ports through which the air bladder is connectable to a source of oscillating pneumatic pressure; and
means for positioning the front panel over a patient's chest so that the front panel approximately covers a lung containing region of a patient's chest.

2. The vest of claim 1 wherein the air bladder engages the front and sides of the patient's chest.

3. The vest of claim 1 wherein the air bladder engages the region of the chest which encompasses the lungs.

4. The vest of claim 1 wherein the front panel has a bib section at its central portion.

5. The vest of claim 1 wherein the central portion has a height between about 9.0 inches and about 13.0 inches.

6. The vest of claim 1 wherein the side portions have a height between about 6.0 inches and about 9.0 inches.

7. The vest of claim 1 wherein the vest is asymmetric from front to back.

8. The vest of claim 1 wherein the vest does not change its general shape during treatment.

9. The vest of claim 1 wherein the compressive force causes the patient's chest to change shape.

10. The vest of claim 1 wherein the vest is constructed from material that when incinerated produces no toxic gas and leaves little particulate matter.

11. The vest of claim 1 wherein a top edge of the front panel is positionable near the patient's collar bone and the bottom edge is positionable near a bottom of the patient's rib cage.

12. The vest of claim 1 wherein the air bladder produces compressive forces of a magnitude to induce deep sputum from the patient's lungs or clear the patient's lungs of mucus.

13. The vest of claim 1 wherein the width of the air bladder is about 21 inches.

14. The vest of claim 1 wherein the means for positioning includes a belt is attached to one side of the front panel.

15. The vest of claim 14 wherein the vest is secured to a patient by wrapping the belt around the patient's back and over the outer surface of the front panel.

16. The vest of claim 1 wherein the means for positioning includes suspenders.

17. The vest of claim 1 wherein an air coupling connects the air bladder and the source of pneumatic pressure by inserting through the air port of the front panel.

18. The vest of claim 1 wherein the air bladder is made of 4 mil polyethylene.

19. A pneumatic chest compression vest comprising:
a generally rigid front panel having an inner surface and a outer surface and a central portion with a height of between about 9 inches and about 13 inches and side portions having a height of between about 6 inches and about 9 inches;
a flexible air bladder mounted on the inner surface of the front panel;
a plurality of air ports through which the air bladder is connectable to a source of oscillating pneumatic pressure; and
a belt for mounting the front panel over a patient's chest so that the front panel approximately covers a lung containing region of a patient's chest.

20. A pneumatic chest compression system comprising:
a front panel;
a flexible air bladder mounted on an inner surface of the front panel;
a belt for holding front panel an the air bladder over a patient's chest;
a source of oscillating pneumatic pressure; and
air connections between the source and the air bladder.

21. The system of claim 20 wherein the front panel includes a central portion having a height of between about 9 inches and about 13 inches.

22. The system of claim 21 wherein the front panel further includes side portions having a height of between about 6 inches and about 9 inches.

23. A method of providing high frequency chest wall oscillation to a patient, the method comprising:
fitting on a patient a vest having a front panel with an air bladder so that the air bladder is positioned in contact with a region of the patient's chest which encompasses the patient's lungs; and
supplying an oscillating pneumatic pressure to the air bladder so that pressure is applied by the air bladder to the patient's lungs.

24. The method of claim 23 wherein fitting the vest includes:
securing the vest in position with a belt which extends around the patient's back and across the front panel; and
securing the vest with suspenders which extend over the patient's shoulders.

25. The method of claim 24 wherein the suspenders are crossed in front of the patient to hold the vest more securely in place.

26. The method of claim 23 wherein the front panel is comprised of a central bib portion and side portions.

27. The method of claim 26 wherein the central bib portion extends from the patient's collar bone to a bottom of the patient's rib cage, and the side portions extend under the patient's arms.

28. The method of claim 23 wherein a supply of oscillating pneumatic pressure is coupled to the air bladder via air couplings inserted through the air ports on the front panel.

29. A method of providing chest wall oscillation to a patient, the method comprising:
positioning a vest on a patient so that an air bladder carried on an inner surface of a front panel of the vest is located adjacent the patient's chest; and
applying pneumatic pressure through the air bladder over an area on a patient's chest from about the bottom of the rib cage to the collarbone.

30. A method providing chest wall oscillation to a patient, the method comprising:
positioning a vest carrying an air bladder so that the air bladder engages only front and sides of the patient's chest; and
applying pressure through the air bladder to the patient's chest.

31. A method of providing high frequency chest wall oscillation to a patient, the method comprising:
mounting on the patient a vest having a front panel with an air bladder so that the air bladder is positioned in contact with a region of the patient's chest which encompasses the patient's lungs; and
supplying an oscillating pneumatic pressure to the air bladder so that pressure is applied by the air bladder to the patient's lungs.

32. The method of claim 31 wherein mounting includes:
securing the vest in position with a belt which extends around the patient's back.

33. The method of claim 31 wherein mounting includes:
securing the vest with suspenders which extend over the patient's shoulders.
